(19) United States
(12) Patent Application Publication
(10) Pub. No.: US 2008/0041269 A1
(43) Pub. Date: Feb. 21, 2008

(54) SILVER INK CONTAINING HUMECTANT MIXTURE FOR INKJET PRINTING

(76) Inventors: Rahel Bekru Bogale, Midway, KY (US); Elaine Yeap Money, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/464,952

(22) Filed: Aug. 16, 2006

(51) Int. Cl. C09D 1/00

(52) U.S. Cl. 106/31.27; 106/31.13

(57) ABSTRACT

The present invention provides an aqueous ink containing ≧3% silver particles having improved jetting performance which can be used reliably for printing of silver traces to obtain desired conductivity on printed media. The humectant (cosolvent) type/loading and surfactant type/loading described herein prevents nozzle drop outs or clogs for a long period of time without an extensive maintenance which is normally required for high solid inks. In a preferred embodiment, the present invention provides silver ink formulation containing humectant mixture of 5-15% 1,2-propanediol and 5-15% of glycol ethers compound with the following structure:

R—[OCH₂CH₂]ₙ—OH

wherein R is a C1-C4 alkyl group and n is 1 to 3. A preferred surfactant is ethoxylated 2,4,7,9-tetramethyl 5 decyn-4,7-diol.

### FIELD OF THE INVENTION

This invention pertains to an aqueous silver inkjet ink having improved jetting performance while meeting resistivity, adhesion and stability requirements.

### BACKGROUND OF THE INVENTION

Silver nanoparticles dispersed in polymer resin are formulated to make conductive ink which is used for printing of electrical elements such as, electroluminescent (EL) displays, radio frequency identification (RFID), multi-layer circuits and membrane circuit applications. Based on its application, silver ink is printed on different types of media. For example for EL display and RFID applications, it is printed on a porous media. For application of multi-layer circuits and membrane circuit application, it is printed on FR4 board (coated with ink receiving layer) and PET transparency, respectively.

Thermal inkjet printing to which this invention relates is now widely practiced. It involves the intense heating of an aqueous ink in a small amount in contact with a heating element so that the ink is vaporized. The vaporized ink, including solids in the ink, is expelled through a nozzle and thereby directed to an intended substrate.

The objective of formulating silver ink is to provide an ink which has <0.1 ohm per square resistivity, adheres well to media, remains stable up to 1 year shelf life and jets properly in an unmodified black ink cartridge such as Lexmark Black Ink Cartridge #32. Conductive ink with such properties is necessary to produce functional electrical elements.

A previous study by Applicants indicated that at least 11% silver loading is required to obtain <0.1 ohm/sq resistivity after <200° C. sintering process in an oven. The solid loading for conductive ink is very high when compared to traditional pigment or dye inks. The high solid loading makes jetting very difficult especially with a traditional printhead which is designed for ˜4% pigment ink. Inks containing high solids normally require extensive maintenance otherwise the nozzles will clog and jetting become unreliable or will not be able to print continuously. Improper jetted ink will lead to poor conductivity, and thus will not be able to produce functional electrical elements. In other words, proper jetting is a must for conductive ink compositions.

There are commercially available stable silver dispersions such as Fine Sphere SVW102 manufactured by Nippon Paint Co., LTD. To improve on silver adhesion to media, an acrylic binder was added to the silver ink. As a result, tape adhesion was greatly improved. However, the addition of binder to the high solid ink intensifies the jetting problem. Extensive formulation work had to be done to jet the silver ink without clogging nozzles.

It would beneficial to be able to jet the high silver loading inks using a commercially available printhead such as Lexmark Black Ink Cartridge #32, without any modification to the printhead design.

### SUMMARY OF THE INVENTION

The present invention provides an aqueous inkjet ink composition for ink jet printers comprising silver particles, a humectant mixture, a surfactant, and an aqueous carrier. In particular, the present invention provides ink containing ≧3% silver solids having improved jetting performance which can be used reliably for printing of silver traces to obtain desired conductivity on printed media. The humectant (co-solvent) type/loading and surfactant type/loading described herein prevents nozzle drop outs or clogs for a long period of time without an extensive maintenance which is normally required for high solid inks.

In a preferred embodiment, the silver ink of the present invention contains a humectant mixture of 5-15% 1,2-propanediol and 5-15% of glycol ethers compound with the following structure:

R—[OCH₂CH₂]ₙ—OH

wherein R is a C1-C4 alkyl group and n=1 to 3. Examples of glycol ethers compounds that showed significant improvement of jetting when a mixed with 1,2-propendiol include: triethylene glycol monobutyl ether, diethylene glycol mono butyl ether and triethylene glycol mono methyl ether.

Applicants have discovered that there is an optimum level of humectant loading in the ink to improve on jetting and adhesion without sacrificing conductivity of the silver ink. For a high solids ink, increasing humectant loading will increase ink viscosity. It is best to maintain ink viscosity under 5 cP. In addition to affecting ink viscosity, increasing humectant loading hurts adhesion of silver ink to media. Inks with 10% or less of humectant loading, show unacceptable performance in jetting. The optimum loading for the disclosed humectant set is 20% total, preferably 10% of each of the two humectants described above.

Surfactant type and loading in the silver ink can also affect jetting performance. The role of surfactant in the ink is to decrease dry time and increase wetting of ink on media. The affinity of surfactant to the silver particle can affect stability and jetting. A study was carried out to evaluate the surfactant type by varying the HLB value of the Surfynol series surfactant from Air Products. In the same study, the surfactant loading was varied from 0 to about 2%. From the ethoxylated diols group of surfactant tested in the study, 1% of Surfynol 465 is preferred for optimum jetting and stability.

The aqueous carrier medium used in the silver ink compositions of the present invention comprises water (preferably deionized water). The aqueous carrier may further comprise a second solvent such as a water soluble organic solvent. Selection of a suitable water miscible solvent depends on the requirements of the specific application involved.

All percentages and ratios, used herein, are “by weight” unless otherwise specified. All molecular weights, used herein, are weight average molecular weights unless otherwise specified. Further details and advantages of the present invention are set forth below in the following more detailed description.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows the pel lines jetted by printhead nozzles containing Ink 1.

FIG. 2 shows the pel lines jetted by printhead nozzles containing Comparative Ink 1.

FIG. 3 shows the pel lines jetted by printhead nozzles containing control Lexmark black pigment Ink.

The exemplifications set out herein illustrate one preferred embodiment of the invention, in one form, and such exemplifications are not to be construed as limiting the scope of the invention in any manner.

### DETAILED DESCRIPTION OF THE INVENTION

The present invention provides ink containing ≧3% silver solids having improved jetting performance which can be used reliably for printing of silver traces to obtain desired conductivity on printed media. The humectant (co-solvent) type/loading and surfactant type/loading described herein prevents nozzle drop outs or clogs for a long period of time without an extensive maintenance which is normally required for high solid inks.

There are commercially available stable silver dispersions such as Fine Sphere SVW102 manufactured by Nippon Paint Co., LTD, and AG400 247360W-1 ID087 manufactured by Cima NanoTech.

The silver ink of the present invention has a ≧3% silver and up to 30% silver by weight of the weight of the ink. Preferred embodiments of a silver ink will have from about 11% silver to about 27% silver, more preferably from about 12% silver to about 20% silver by weight of the weight of the ink.

The particle size (diameter) of the silver would typically be less than 50 nanometers (nm) for the best resolution and minimal settling. Particle sizes between about 15 nm to about 50, more preferably between about 20 to 42 nm are generally preferred for the same reasons. An upper limit to prevent excess settling is about 132 nm.

It should be understood however, that some settling may be tolerable as the printing of metal particles is often done in a controlled environment, such as a factory, where the ink can be readily stirred or settling otherwise reversed.

It has been found that jetting can be greatly improved by choosing a humectant set which consist of mixture of 1,2-Propanediol and a glycol ethers compound having the following structure:

R—[OCH₂CH₂]ₙ—OH

where R is a C1-C4 alkyl group and n=1 to 3. Examples of glycol ethers compounds that showed significant improvement of jetting when a mixed with 1,2-propendiol include: triethylene glycol monobutyl ether, diethylene glycol mono butyl ether and triethylene glycol mono methyl ether.

There is an optimum level of humectant loading in the ink to improve on jetting and adhesion without sacrificing conductivity of the silver ink. For a high solids ink, increasing humectant loading will increase ink viscosity. It is best to maintain ink viscosity under 5 cP. In addition to affecting ink viscosity, increasing humectant loading hurts adhesion of silver ink to media. Inks with 10% or less of humectant loading, show unacceptable performance in jetting. The optimum loading for the disclosed humectant set is 20% total, preferably 10% of each of the two humectants).

Without being bound by theory, it is believe that the glycol ethers compound with “—OH” hydroxy group gives high affinity to silver particles, while the short hydrocarbon chain provides a less hydrophobic group and therefore improves jetting considerably.

Surfactant type and loading in the silver ink can also affect jetting performance. The role of surfactant in the ink is to decrease dry time and increase wetting of ink on media. The affinity of surfactant to the silver particle can affect stability and jetting. A study was carried out to evaluate the surfactant type by varying the HLB value of the Surfynol series surfactant from Air Products. In the same study, the surfactant loading was varied from 0 to about 2%. From the ethoxylated diols group of surfactant tested in the study, 1% of Surfynol 465 was preferred for optimum jetting and stability.

It is recommended that from about 0.1% to about 2.0%, more preferably, about 1.0% of an acetylene glycol surfactant, preferably, ethoxylated 2,4,7,9-tetramethyl 5 decyn-4,7-diol (commercially available as Surfynol 465) be used as a surfactant in the ink for further jetting improvement.

Importantly, Applicants have found that the optimum levels of the humectant mixture and surfactant discussed above, result in a good balance of adhesion, resistivity, stability and jetting of silver ink.

The aqueous carrier medium used in the silver ink compositions of the present invention comprises water (preferably deionized water). The aqueous carrier may further comprise a second solvent such as a water soluble organic solvent. Selection of a suitable water miscible solvent depends on the requirements of the specific application involved. Representative examples of water soluble organic solvents that may be selected include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols, such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol, 1,2,6-hexanetriol and thiodiglycol; (6) lower alkyl mono- or di-ethers derived from alkylene glycols, such as ethylene glycol monomethyl (or monoethyl) ether, diethylene glycol monomethyl (or monoethyl)ether, propylene glycol monomethyl (or monoethyl)ether, triethylene glycol monomethyl (or monoethyl)ether and diethylene glycol dimethyl (or diethyl)ether; (7) nitrogen-containing cyclic compounds, such as pyrrolidone, N-methyl-2-pyrrolidone, and 1,3-dimethyl-2-imidazoli-dinone; and (8) sulfur-containing compounds, such as dimethyl sulfoxide and tetramethylene sulfone. Other useful organic solvents include lactones and lactams. Mixtures of these solvents may be used in the present invention.

Biocides, such as for example, 1,2-benz-isothiazolin-3-one, sold commercially as PROXEL GXL, may be added to the ink to prevent or inhibit growth of microorganisms in the ink. Generally, the addition of from about 0.1 to about 0.2% by weight of a biocide will be effective in reducing the gram positive and negative bacteria as well as mold growth.

### EXAMPLES

The following examples are detailed descriptions of methods of preparation and use of the aqueous silver ink compositions of the present invention. The detailed descriptions fall within the scope of, and serve to exemplify, the more general description set forth above. The examples are presented for illustrative purposes only, and are not intended as a restriction on the scope of the invention.

The following inks contain DI water, 14% silver, 0.5% Surfynol 465 surfactant and humectant type and level listed in Table 1. The viscosity of the inks ranged from 2.94 to 4.83 cP at 23.94° C., with surface tension of 36 dyne/cm. The silver dispersion used in ink was Fine Sphere SVW102 manufactured by Nippon Paint Co., LTD. Ink particle sizes ranged from 20 nm to 42 nm.

TABLE 1
Humectant Type in Silver Ink:

| | Humectant Type | | |
|---|---|---|---|
| | in Ink: | | |
| | Ink 1 | Ink 2 | Ink 3 |
| 1,2-Propanediol | 10% | 10% | 10% |
| Triethylene glycol monobutyl | 10% | | |
| ether(TEGMBE) | | | |
| Diethylene glycol mono butyl | | 10% | |
| ether(DEGMBE) | | | |
| Triethylene glycol mono methyl ether | | | 10% |
| (TEGMME) | | | |

| Humectant | Comparative Ink (Comp Ink) In Percent | | | | | | | | | | | |
|---|---|---|---|---|---|---|---|---|---|---|---|---|
| Type in Ink: | 1 | 2 | 3 | 4 | 5 | 6 | 7 | 8 | 9 | 10 | 11 | 12 |
| Glycerol | 10 | | | | | | | | | | | |
| 2-pyrrolidone | 10 | | | | | | | | | | | |
| 1,2- | | 20 | 10 | 10 | 10 | 10 | 10 | 10 | 10 | 10 | | 10 |
| Propanediol | | | | | | | | | | | | |
| 1,2-Butanediol | | | 10 | | | | | | | | | |
| 1,3-Butanediol | | | | 10 | | | | | | | | |
| 2,3-Butanediol | | | | | 10 | | | | | | | |
| 1,3- | | | | | | 10 | | | | | | |
| Propanediol | | | | | | | | | | | | |
| 2-methyl-2, | | | | | | | 10 | | | | | |
| 4-pentanediol | | | | | | | | | | | | |
| 2,2- | | | | | | | | 10 | | | | |
| thiodiethanol | | | | | | | | | | | | |
| Tetraethylene | | | | | | | | | 10 | | | |
| glycol | | | | | | | | | | | | |
| 2-methyl-1, | | | | | | | | | | 10 | | |
| 3-propanediol | | | | | | | | | | | | |
| Tripropylene | | | | | | | | | | | | 10 |
| glycol methyl | | | | | | | | | | | | |
| ether | | | | | | | | | | | | |
| Triethylene | | | | | | | | | | | 20 | |
| glycol | | | | | | | | | | | | |
| mono butyl | | | | | | | | | | | | |
| ether | | | | | | | | | | | | |

The inks were tested in a Lexmark Z816 printer for jetting evaluation. The testing was performed without maintenance.

Idle Time—amount of time (in seconds) allowable for printhead (nozzles) to be idle on carrier, without degradation of print quality on the first jetted ink drop on paper.

5 Million Fires—amount of fires per nozzle

Pass=less than 1.25% of nozzles misfired (misdirection, weak, missing)

Borderline Pass=1.25% to 1.875% of nozzles misfired

Fail=1.875% or more nozzles misfired

Ungradable=1.875% or more nozzles misfired at the beginning, before going through the million fires test

Start up—printheads were uncapped (exposed to open air) for 24 hours, nozzle down position

Good=10% or less missing nozzles

Bad=>10% of missing nozzles

For a control black pigment ink in Lexmark Z816 printer, it would pass for all tests described above with idle time of at least 4 seconds. Table 2 summarizes the results. Ink 1, 2 and 3 were unique where jetting greatly improved using the humectant set as disclosed. Comparative Ink 2 and Comparative Ink 11 resulted in poor jetting when the individual humectant was used in the ink. For resistivity measurement, the printed silver traces were sintered in an oven at 150° C. The ink was printed at 720,069 dpi. The resistivity of all inks in Table 2 meet the <0.1 D/square resistivity requirement (except comp Ink 8 which had a resistivity of 0.11 D/square). Comp ink 8 has a sulfur containing humectant.

TABLE 2
Humectant Type vs Jetting Results

| | Idle | 5 Million | Start |
|---|---|---|---|
| | Time | Fires | Up |
| Ink 1 | 5.0 | Pass | Good |
| Ink 2 | >8.0 | Pass | Good |
| Ink 3 | 7.0 | Pass | Good |
| Comp Ink 1 | 0 | Ungradable | Bad |
| Comp Ink 2 | 0.5 | Ungradable | Bad |
| Comp Ink 3 | 2.0 | Pass | Bad |
| Comp Ink 4 | 1.5 | Borderline | Bad |
| | | Pass | |
| Comp Ink 5 | 2.0 | Fail | Bad |
| Comp Ink 6 | 0 | Fail | Bad |
| Comp Ink 7 | 8.0 | Pass | Bad |
| Comp Ink 8 | 0 | Ungradable | Bad |
| Comp Ink 9 | 0 | Ungradable | Bad |
| Comp Ink 10 | 1.0 | Fail | Good |
| Comp Ink 11 | 0 | Ungradable | Bad |
| Comp Ink 12 | 2.0 | Borderline | Good |
| | | Pass | |

The inks in Table 3 contain DI water, 14% silver, 0.5% Surfynol 465 and the humectant loading as shown in Table 3. The inks were tested in a Lexmark Z816 printer for jetting evaluation using same criteria as mentioned above. Table 4 summarizes the results where humectant loading can improve jetting considerably. This experiment was carried out without using the disclosed humectant set, but it shows the impact of humectant loading on jetting. The resistivity of inks in Table 3 were 0.05 to 0.08 Ω/square which met the <0.1 Ω/square resistivity requirement.

TABLE 3
Humectant in Silver Ink

| Humectant | | Ink | Ink | Ink | |
|---|---|---|---|---|---|
| Load: | Ink I | II | III | IV | Ink V |
| 2-Pyrrolidone | 15 | 10 | 7.5 | 5 | 2.5 |
| Glycerol | 15 | 10 | 7.5 | 5 | 2.5 |
| Total | 30 | 20 | 15 | 10 | 5 |
| Humectant | | | | | |

TABLE 4
Humectant Loading vs Jetting Results

| Jetting: | Ink I | Ink II | Ink III | Ink IV | Ink V |
|---|---|---|---|---|---|
| Idle Time | 5.0 | 0.5 | 0.5 | Ungradable | Ungradable |
| 5 Million | Pass | Borderline | Borderline | Fail | Ungradable |
| Fires | | Pass | Pass | | |
| Start Up | Bad | Bad | Bad | Bad | Bad |

The following inks contain DI water, 14% silver, 0.5% Surfynol 465 and the humectant type and loading as listed in Table 5. Table 6 shows the impact of humectant loading on silver adhesion to media. By increasing humectant loading in the silver ink, adhesion of silver ink to paper degrades. The adhesion test was carried out by using a PCB Blue Cruiser Tape (purchased from IPS Limited Co.), which was placed over the sintered ink where the grid had been trace while applying pressure. The tape was then removed with medium speed to determine the adhesion. If the tape removes 10% of the grids, adhesion equals 90%. The adhesion requirement of silver ink is 80% or greater.

TABLE 5
Humectant Type and Loading in Silver Ink

| | Ink | Ink | Ink | | |
|---|---|---|---|---|---|
| Humectant | VI | VII | VII | Ink IX | Ink X |
| 1,2-Propanediol | 10 | 15 | 10 | 12.5 | 15 |
| 2-pyrrolidone | 10 | 15 | | | |
| 1,3-Butanediol | | | 10 | 12.5 | 15 |

TABLE 6
Humectant Loading vs. Adhesion Results

| | | Ink | Ink | | |
|---|---|---|---|---|---|
| Humectant | Ink VI | VII | VIII | Ink IX | Ink X |
| Adhesion | 95% | 70% | 55% | 50% | 47% |

The following inks contain DI water, 10% 2-Pyrrolidone, 10% Glycerol and surfactant type as listed in Table 7. The data in Table 8 show that by choosing the correct HLB value of surfactant, jetting can be improved. Surfynol 465 performed best on jetting which has a HLB value of 13, therefore it is recommended in the silver ink. Resistivity of inks A to D were 0.04 to 0.07 Ω/square (met requirement).

TABLE 7
Surfactant Type in the Silver Ink

| Surfactant: | Ink A | Ink B | Ink C | Ink D |
|---|---|---|---|---|
| Surfynol | 1% | | | |
| 2502 | | | | |
| Surfynol | | 1% | | |
| FS80 | | | | |
| Surfynol | | | 1% | |
| 465 | | | | |
| Surfynol | | | | 1% |
| 485 | | | | |

TABLE 8
Surfactant Type vs Jetting Results

| | Idle | | Start |
|---|---|---|---|
| Ink | Time | 5MF | Up |
| Ink A | 0 | Borderline | Bad |
| | | Pass | |
| Ink B | 0 | Borderline | Bad |
| | | Pass | |
| Ink C | 1.0 | Pass | Good |
| Ink D | 0 | Fail | Bad |

The following inks contain DI water, 10% 2-Pyrrolidone, 10% Glycerol and surfactant type as listed in Table 9. The data in Table 10 show that 1% Surfynol 465 in the ink is optimum for jetting. Resistivity of inks in Table 9 was 0.05 to 0.07 Ω/square (met requirement).

TABLE 9
Surfactant Loading in the Silver Ink

| % Surfactant: | Ink E | Ink F | Ink C | Ink G |
|---|---|---|---|---|
| Surfynol 465 | 0% | 0.5% | 1% | 2% |

TABLE 10
Surfactant Loading vs. Jetting Results

| | | | Start |
|---|---|---|---|
| Ink | Idle Time | 5MF | Up |
| Ink E | Ungradable | Ungradable | Bad |
| Ink F | Ungradable | Ungradable | Bad |
| Ink C | 1.0 | Pass | Good |
| Ink G | 1.0 | Borderline | Good |
| | | Pass | |

Ink 1 and 2 and were stored in oven for up to 4 weeks at 60° C. Particle size and viscosity of the inks were monitored. Particle size of inks remains under 50 nm and ink viscosity were unchanged after oven aging. Therefore the recommended inks in this invention are stable for 4 weeks at 60° C. (which is equivalent to 1 year shelf life).

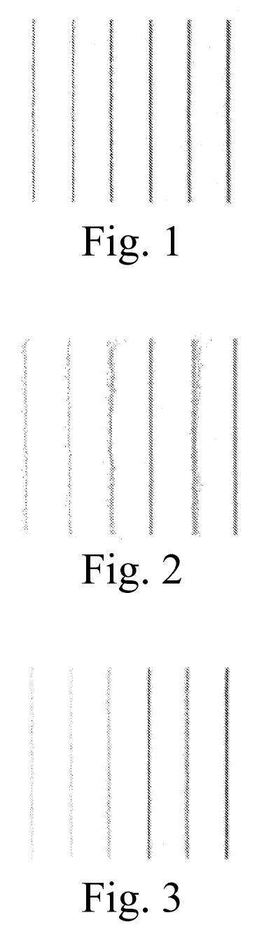

FIG. 1 shows the jetting performance after letting ink in printhead idle for 8 seconds. Much less misfires and missing nozzles for Ink 1 compare to Comparative Ink 1 (FIG. 2) or the control Lexmark Black pigment ink (FIG. 3), which the printhead is designed for.

In summary, this invention provides a silver ink with much improved jetting while able to meet the <0.1 Ω/square resistivity requirement yet exhibit great adhesion property and remain stable for up to 4 weeks at 60° C. at accelerated oven aging condition.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An aqueous inkjet ink composition for ink jet printers comprising silver particles, a humectant mixture, a surfactant, and an aqueous carrier.

2. The aqueous inkjet ink of claim 1 wherein the humectant mixture comprises a mixture of 1,2-propanediol and a glycol ethers compound having the structure:
R—[OCH₂CH₂]ₙ—OH
where R is a C1-C4 alkyl group and n is 1-3.

3. The aqueous inkjet ink of claim 2 wherein said aqueous ink jet ink comprises from about 5 to about 15% of the 1,2-propanediol and from about 5 to about 15% of the glycol ethers compound.

4. The aqueous inkjet ink of claim 3 wherein the glycol ethers compound is selected from the group consisting of: triethylene glycol monobutyl ether, diethylene glycol mono butyl ether, triethylene glycol mono methyl ether, and mixtures thereof.

5. The aqueous inkjet ink of claim 3 wherein said aqueous ink jet ink comprises from about 0.1% to about 2.0% of the surfactant.

6. The aqueous inkjet ink of claim 5 wherein said surfactant is ethoxylated 2,4,7,9-tetramethyl 5 decyn-4,7-diol.

7. The aqueous inkjet ink of claim 3 wherein said aqueous ink jet ink comprises from ≧3% to about 30% of the silver particles.

8. The aqueous inkjet ink of claim 7 wherein said aqueous ink jet ink comprises from about 11% to about 27% of the silver particles.

9. The aqueous inkjet ink of claim 7 wherein said silver particles have a diameter in the range of from about 15 nm to about 50 nm.

10. The aqueous inkjet ink of claim 9 wherein said silver particles have a diameter in the range of from about 20 nm to about 42 nm.

11. The aqueous inkjet ink of claim 9 wherein said aqueous ink jet ink comprises from about 0.1% to about 2.0% of the surfactant.

12. The aqueous inkjet ink of claim 11 wherein said surfactant is ethoxylated 2,4,7,9-tetramethyl 5 decyn-4,7-diol.

13. The aqueous inkjet ink of claim 12 wherein the glycol ethers compound humectant is selected from the group consisting of: triethylene glycol monobutyl ether, diethylene glycol mono butyl ether, triethylene glycol mono methyl ether and mixtures thereof.

14. The aqueous inkjet ink of claim 13 wherein said silver particles have a diameter in the range of from about 20 nm to about 42 nm.
